(19) United States
(12) Patent Application Publication
(10) Pub. No.: US 2025/0229846 A1
(43) Pub. Date: Jul. 17, 2025

(54) VEHICLE UNDERCOVER AND METHOD FOR MANUFACTURING THE SAME

(71) Applicant: Howa Co., Ltd., Kasugai-shi, Aichi (JP)

(72) Inventor: Yuichiro INAGAKI, Kasugai-shi, Aichi-ken (JP)

(21) Appl. No.: 18/849,042

(22) PCT Filed: Feb. 24, 2023
(86) PCT No.: PCT/JP2023/006643

§ 371 Date: Sep. 20, 2024

(30) Foreign Application Priority Data
Apr. 5, 2022 (JP) 2022-062833

(51) Int. Cl. B62D 25/24; B62D 25/20

(52) U.S. Cl. CPC B62D 25/24; B62D 25/20

(57) ABSTRACT

A vehicle undercover for covering an underside of a vehicle body includes a main body formed from a planar press-molded body. A service hole to allow access to vehicle accessories is formed in the main body. A material corresponding to the service hole is separated from the main body. A lid configured to close at least a portion of the service hole is formed from the separated material. By shifting the lid relative to the service hole in a planar direction, an overlapping portion is formed where a portion of the main body at a peripheral edge of the service hole and a portion of an outer peripheral side of the lid overlap. The lid is fixed to the main body at the overlapping portion by fixing portions.

### CROSS-REFERENCE TO RELATED APPLICATIONS

The present application is a 35 U.S.C. § 371 U.S. National Phase entry of, and claims priority to, PCT Application PCT/JP2023/006643 filed Feb. 24, 2023, which claims priority to Japanese Patent Application No. 2022-062833 filed Apr. 5, 2022, which is hereby incorporated herein by reference in its entirety for all purposes.

### BACKGROUND

One aspect of the present disclosure relates to a vehicle undercover and a method for manufacturing the same.

Conventionally, a service hole is provided in a vehicle engine undercover for oil changes, equipment inspections, etc. When the vehicle is in use, the service hole is closed with a lid. Engine undercovers are manufactured by various methods such as press molding and injection molding. For example, JP2020-82778A discloses an engine undercover manufactured by injection molding. This engine undercover is formed by integrally molding a main body of the engine undercover provided with an inspection port and a lid that closes the inspection port.

In recent years, due to stricter regulations on vehicle external noise, a main body of an engine undercover and a lid that covers a service hole are more frequently made of fiber materials that have sound-absorbing properties. An engine undercover using a fiber material is manufactured by press-molding a sheet of material referred to as a raw sheet. Because the lid that closes the service hole of the main body is fixed with its outer peripheral edge overlapping the main body, the lid is molded to have a larger dimension than the service hole. In this case, the lid is formed in an area different from the main body on the plane of the raw sheet. As a result, the size of the raw sheet required to form the engine undercover increases, and the material yield tends to deteriorate.

Therefore, there has been a need for a vehicle undercover and a method for manufacturing the same that can improve the material yield of a raw sheet to be press-molded.

### SUMMARY

According to one aspect of the present disclosure, a vehicle undercover is configured to cover an underside of a vehicle body, and has a main body made of a planar press-molded body.

A service hole penetrating in the thickness direction is opened in a certain area of the main body. The service hole allows access to vehicle accessories. A separated part of an inner area bounded by a peripheral edge of the service hole is used as a lid that covers at least a portion of the service hole. By moving the lid relative to the service hole in the planar direction, a portion of the peripheral edge of the service hole and a portion of an outer peripheral side of the lid overlap to form an overlapping portion. At the overlapping portion, the lid is fixed to the main body by a fixing portion.

According to the above configuration, a molded body which is a separated part of the area inside the service hole is used as the lid. The lid is arranged with a portion of the outer peripheral side of the lid overlapping with a portion of the main body at the peripheral edge of the service hole to form the overlapping portion. The overlapping portion may prevent a gap from forming between the peripheral edge of the service hole and the lid. Further, the dimension of the remaining opening of the service hole that is not covered by the lid is small. It is possible to close the opening with a member that uses an area with a limited dimension of the raw sheet. Thereby, there is no need to form a lid having a dimension larger than the service hole outside the area of the main body on the plane of the raw sheet. This configuration improves the material yield while ensuring the function as a lid to cover the service hole of the main body.

According to another aspect of the present disclosure, the service hole and the lid may have a substantially rectangular shape with a long side and a short side facing each other. The lid is disposed at a position moved from the long side to the short side of the service hole along the plane of the main body. As a result, the lid covers at least a portion of the service hole.

Therefore, the service hole and the lid are formed to have a shape with a width becoming narrower toward the shorter side. The lid is disposed at a position moved from the long side to the short side of the service hole. Therefore, overlapping portions are formed in a region along the short sides of the service hole and the lid, and along two sides adjacent to the short side. Thereby, the overlapping portions may be efficiently configured on three sides of the service hole and the lid.

According to another aspect of the present disclosure, the main body may have a first stepped portion at the overlapping portion. The first stepped portion has a height difference relative to a main body surface. The lid may have a second stepped portion at the overlapping portion. The second stepped portion has a height difference relative to a lid surface of the lid.

A height position of the lid surface and a height position of the main body surface are aligned when the lid covers at least a portion of the service hole.

Therefore, at the overlapping portion, the first stepped portion of the main body and the second stepped portion of the lid overlap in the thickness direction. A height difference is provided between a portion of the main body and a portion of the lid those portions overlap each other at the overlapping portion. This allows the service hole to be covered with the main body surface and the lid surface aligned at the same height. In other words, it is possible to reduce the size and the number of unevenness on the surface of the vehicle undercover.

According to another aspect of the present disclosure, the lid may have a convex insertion portion on one side of the outer peripheral side of the lid. The insertion portion engages with a portion of the main body at the peripheral edge of the service hole. This allows the lid to be temporarily assembled to the main body. Therefore, when the lid is fixed to the main body at the fixing portion, the position of the lid is secured. As a result, work efficiency may be improved.

Another aspect of the present disclosure is a method for manufacturing a vehicle undercover that covers an underside of a vehicle body. The undercover has a service hole to allow access to vehicle accessories, and a lid that covers at least a portion of the service hole. The manufacturing method includes a press molding process. In the press molding process, a planar main body is molded, and the lid is molded in a region inside of the service hole provided in a certain area of the main body. The lid is separated from the main body, and the service hole is formed in the main body. The lid is shifted relative to the service hole in a planar direction. As a result, a portion of the main body at a peripheral edge of the service hole and a portion of an outer peripheral side of the lid overlap to form an overlapping portion. The lid is fixed to the main body at the overlapping portion.

Therefore, the main body is provided with the service hole that penetrates in the thickness direction. The region inside the service hole is formed as the lid and separated from the main body. The lid is disposed thereby a part on its outer peripheral side is disposed to overlap with a peripheral edge of the service hole of the main body, and the lid is fixed to the main body. This may prevent a gap from forming between the peripheral edge of the service hole and the lid. Further, the remaining opening of the service hole that is not covered by the lid has a small dimension. Therefore, a member that covers the opening may be formed even in an area where the dimension of the raw sheet is limited. Therefore, there is no need to form a lid having a larger dimension than the service hole outside the area of the main body on the plane of the raw sheet. This configuration may improve the material yield while ensuring the function of the lid that covers the service hole of the main body.

According to another aspect of the present disclosure, the lid is formed with a convex insertion portion on one side of its peripheral edge. When the lid is shifted relative to the service hole in a planar direction, the insertion portion engages with a part of the peripheral edge of the service hole. Thereby, the lid may be temporarily assembled to the main body. Therefore, when the lid is fixed to the main body at the fixing portions, the position of the lid is secured. As a result, work efficiency can be improved.

### BRIEF DESCRIPTION OF THE DRAWINGS

FIG. 1 is a schematic plan view of a vehicle undercover according to a present embodiment.

FIG. 2 is a plan view of a service hole and a lid when a main body of the vehicle undercover is press-molded.

FIG. 3 is a plan view illustrating when the lid is shifted relative to the service hole.

FIG. 4 is a cross-sectional view taken along a line IV-IV at oblique sides of the service hole and the lid in FIG. 2.

FIG. 5 is a cross-sectional view taken along a line V-V at the oblique sides of the service hole and the lid in FIG. 3.

FIG. 6 is a cross-sectional view taken along the line VI-VI at a fixing portion in FIG. 2.

FIG. 7 is a cross-sectional view taken along the line VII-VII at the fixing portion in FIG. 3.

FIG. 8 is a cross-sectional plan view illustrating when a fixing portion according to another embodiment is press-molded.

FIG. 9 is a cross-sectional plan view illustrating when the lid is shifted relative to the fixing portion according to another embodiment.

FIG. 10 is a cross-sectional view taken along a line X-X at an insertion portion in FIG. 2.

FIG. 11 is a cross-sectional view taken along a line XI-XI at the insertion portion in FIG. 3.

FIG. 12 is a cross-sectional view taken along a line XII-XII at long sides of the service hole and the lid in FIG. 2.

FIG. 13 is a cross-sectional view taken along a line XIII-XIII at the long sides of the service hole and the lid in FIG. 3.

FIG. 14 is a view illustrating when an opening in FIG. 13 is closed with an auxiliary member.

FIG. 15 is a schematic plan view of a service hole and a lid according to another embodiment.

### DETAILED DESCRIPTION

### <Vehicle Undercover>

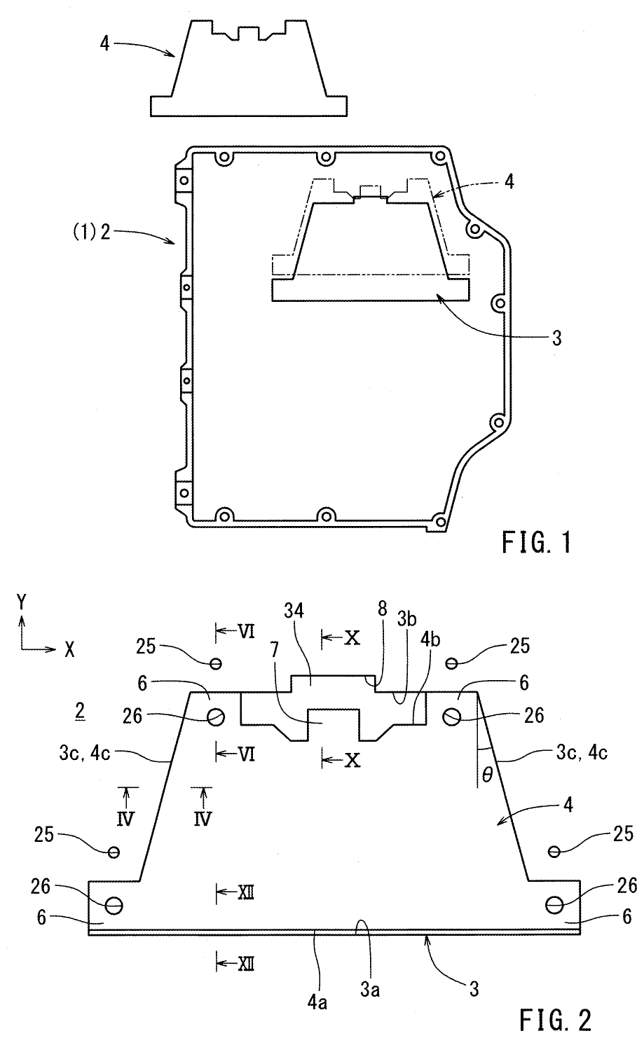

Hereinafter, one exemplary embodiment of the present disclosure will be described with reference to the drawings. An engine undercover 1 will be described as an example of the vehicle undercover of the present embodiment. The engine undercover 1 is attached to a lower side of an engine so as to cover an underside of a vehicle body to protect the engine. The engine undercover 1 includes a main body 2 and a lid 4, as shown in FIG. 1. The main body 2 is provided with a service hole 3 to allow access to vehicle accessories. At least a portion of the service hole 3 is covered by the lid 4.

The main body 2 of the engine undercover 1 is composed of a three-dimensional planar fiber molded body. The fiber molded body is formed by press-molding a raw sheet made of a fiber base material. The fiber base material may include, for example, material containing a thermoplastic synthetic resin and a fiber reinforced material. As the thermoplastic synthetic resin, olefins such as polypropylene, polyesters such as polyethylene terephthalate, polyamides, etc. may be selected. As the fiber reinforced material, in addition to glass fiber, basalt fiber, and carbon fiber, natural fibers such as kenaf (western hemp) and bamboo may be appropriately selected.

The fiber base material can be manufactured by a known manufacturing method such as a dry method using needle punching or a wet paper making method. The fiber base material also includes binder fibers. The binder fiber may be, for example, a thermoplastic synthetic resin such as polypropylene fiber. The fiber base material may be, for example, low weight reinforced thermoplastics (LWRT). The LWRT may use, for example, polypropylene fiber as the binder fiber and glass fiber as the fiber reinforcement material. Alternatively, a fiber base material containing no fiber reinforced material may be used as the fiber base material. For example, a needle punched nonwoven fabric base material (molded nonwoven fabric) using polyethylene terephthalate fibers and binder fibers such as low melt polyester fibers may be used. Furthermore, these fiber base materials may be formed into a multilayered body by laminating additional nonwoven fabrics or films to improve stone chip resistance, smoothness, and the like.

As shown in FIG. 1, the service hole 3 is an opening that penetrates a certain area of the main body 2 in the thickness direction, and is configured to allow access to vehicle accessories. The service hole 3 is a closed area enclosed by the main body 2. The lid 4 may be a separated part of an inner region of the main body 2 bordered by a peripheral edge of the service hole 3, and is a molded body made of the same fiber base material as the main body 2.

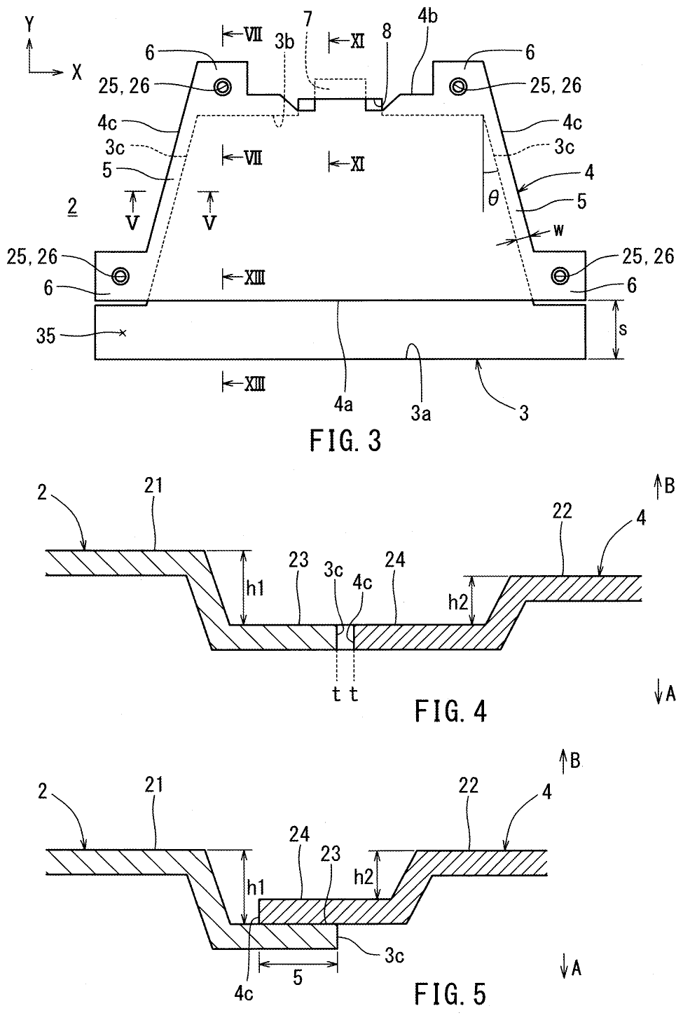

As shown in FIG. 2, the service hole 3 has a substantially rectangular shape with a long side 3a (long side of the hole) and a short side 3b (short side of the hole) facing each other. The lid 4 has a substantially rectangular shape with a long side 4a (long side of the lid) and a short side 4b (short side of the lid) facing each other. This shape may be a substantially trapezoidal shape having the long side 3a or 4a, the short side 3b or 4b, and adjacent oblique sides 3c or 4c. As shown in FIG. 3, the lid 4 is arranged so that at least a portion of the service hole 3 is covered. If the direction along the long side 3a of the service hole 3 and the long side 4a of the lid 4 is defined as an x-direction, and the direction intersecting the x-direction is defined as a y-direction, the lid 4 separated from the main body 2 is disposed at a location shifted to a direction directed from the long side 3a to the short side 3b of the service hole 3 along the plane of the main body 2, i.e. the y-direction. Since each width of the service hole 3 and the lid 4 is formed to have a width that narrows toward the short sides 3b and 4b, an overlapping portion 5 is formed at the short sides 3b and 4b and the adjacent oblique sides 3c and 4c of the service hole 3 and the lid 4. The overlapping portion 5 is a portion where a portion of the inner peripheral side of the service hole 3 and a portion of the outer peripheral side of the lid 4 overlap by moving the lid 4 relative to the service hole 3 in the planar direction.

An inclination angle θ of the oblique sides 3c and 4c of the service hole 3 and the lid 4 may be freely set as shown in FIG. 3. When the inclination angle θ is small, it is necessary to increase an amount of slides in the y-direction to ensure the width of the overlapping portion 5 (amount of overlap w). On the other hand, if the inclination angle θ is large, it is easy to ensure the amount of overlap w, however if the inclination angle θ becomes too large, the shape of the service hole 3 will be restricted. Therefore, the inclination angle θ of the oblique sides 3c and 4c is set in consideration of the balance between the amount of overlap w and the amount of slide s. Then, the lid 4 separated from the main body 2 is placed at a position slid in the planar direction from the position during press molding. As a result, the overlapping portion 5 is formed along three sides of the service hole 3 and the lid 4.

It should be noted that the inclination angles θ of the two oblique sides 3c and 4c may be the same or may be different angles. Moreover, it is also possible to configure that only one of the two sides adjacent to the long sides 3a, 4a and the short sides 3b, 4b is inclined, while the other side is not inclined. In this case, the overlapping portion 5 may be configured by relatively moving the lid 4 not only along the y-direction but also along the x-direction.

As shown in FIGS. 3 and 5, the main body 2 has a main body stepped portion 23 (first stepped portion) at a location corresponding to the overlapping portion 5. The main body stepped portion 23 may be formed along the inner peripheral edge of the service hole 3. For example, the main body stepped portion 23 is formed along the entire length of the oblique sides 3c and the entire length of the short side 3b of the service hole 3. The main body stepped portion 23 has a height difference with respect to the height position of a surface 21 (main body surface) of the main body 2. The lid 4 has a lid stepped portion 24 (second stepped portion) at a location corresponding to the overlapping portion 5. The lid stepped portion 24 may be formed along the outer peripheral edge of the lid 4. For example, the lid stepped portion 24 is formed along the entire length of the oblique sides 4c and the entire length of the short side 4b of the lid 4. The lid stepped portion 24 has a height difference with respect to the height position of a surface 22 (lid surface) of the lid 4. The surfaces 21 and 22 become a road surface side B, namely, a lower surface when the main body 2 and the lid 4 are attached to the vehicle. As shown in FIGS. 2 and 4, the main body stepped portion 23 and the lid stepped portion 24 are recessed toward the vehicle body side A from the surfaces 21 and 22 of the main body 2 and the lid 4. As a result, the overlapping portion 5 also has a recessed shape toward the vehicle body side A.

As shown in FIGS. 4 and 5, the height difference between the surface 21 of the main body 2 and the main body stepped portion 23 is a step height h1 of the main body 2. The height difference between the surface 22 of the lid 4 and the lid stepped portion 24 is a step height h2 of the lid 4. The step height h1 of the main body 2 and the step height h2 of the lid 4 are set to differ by a thickness of the lid 4. During press molding shown in FIG. 4, the main body stepped portion 23 and the lid stepped portion 24 are at the same height position. That is, the oblique sides 3c and 4c of the service hole 3 and the lid 4 are at the same height position. In the state shown in FIG. 5, the surface 21 of the main body 2 and the surface 22 of the lid 4 are at substantially the same height position.

In a position (see FIGS. 3 and 5) where the lid 4 has relatively shifted from the position during press molding (see FIGS. 2 and 4), the lid 4 covers at least a portion of the service hole 3. The main body stepped portion 23 and the lid stepped portion 24 overlap in the thickness direction to form the overlapping portion 5. The height positions of the surface 22 of the lid 4 and the surface 21 of the main body 2 are aligned. The surfaces 21 and 22 of the main body 2 and the lid 4 do not necessarily have to be in the same height position, but it is more preferable if they are aligned. In the region along the oblique sides 3c and 4c of the overlapping portion 5, the lid stepped portion 24 is located closer to the road surface side B than the main body stepped portion 23.

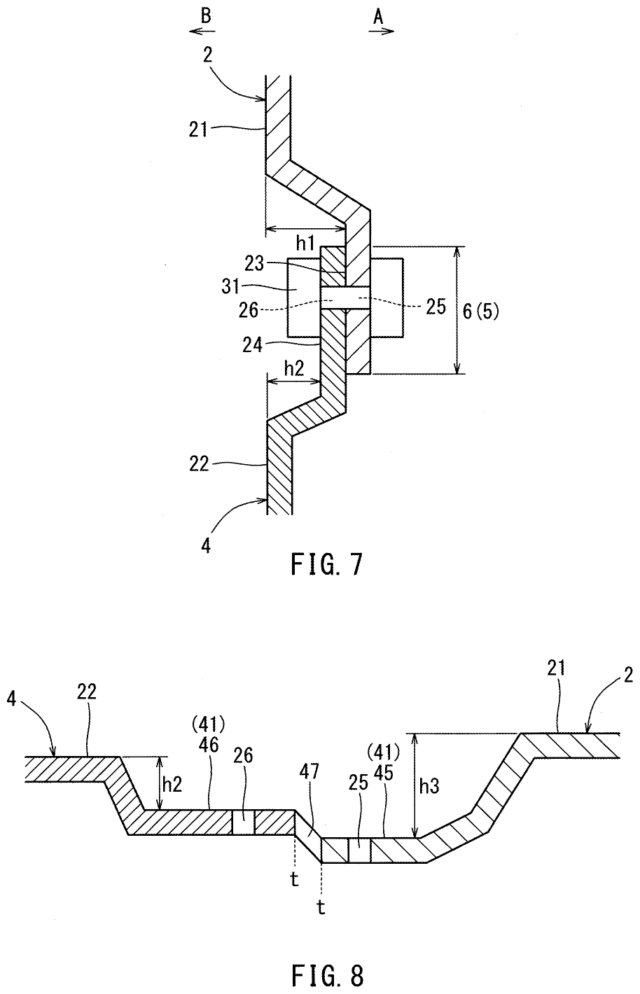

As shown in FIGS. 3 and 7, the overlapping portion 5 has fixing portions 6 where the lid 4 is fixed while overlapping the main body 2. The fixing portions 6 are provided at four corners of the lid 4. At the fixing portion 6, the lid stepped portion 24 is located closer to the road surface side B than the main body stepped portion 23. The main body stepped portion 23 has the same step height h1 both in the region along the oblique sides 3c of the service hole 3 and in the region along the short side 3b. The lid stepped portion 24 also has the same step height h2 both in the region along the oblique sides 4c of the lid 4 and in the region along the short side 3b.

As shown in FIG. 7, the fixing portion 6 has a fastening member 31. The fastening member 31 passes through an attachment hole 25 or 26 that pass through the main body stepped portion 23 and the lid stepped portion 24 in the thickness direction. As the fastening member 31, for example, a bolt and a nut may be selected. Therefore, the lid stepped portion 24 is fixed to the main body stepped portion 23 by the fastening member 31. The attachment hole 25 of the main body 2 is provided corresponding to the position where the fixing portion 6 of the lid 4 has slidably moved in the y-direction. Depending on the shape of the attachment holes 25, 26 and the fastening member 31 in the fixing portion 6, the amount of slide s of the lid 4 is appropriately set, ensuring the amount of overlap w.

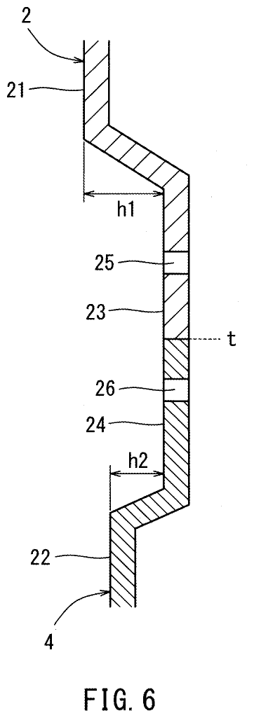

As shown in FIG. 6, during press molding, the main body stepped portion 23 and the lid stepped portion 24 around the fixing portion 6 (attachment holes 25, 26) are set to arrange at the same height. By press-molding in this manner, it is possible to prevent the material from being unnecessarily stretched at the boundary between the main body 2 and the lid 4 during press-molding, thereby preventing the occurrence of low-density portions. During press molding, the main body stepped portion 23 and the lid stepped portion 24 are arranged so as to come in contact with each other. Only one trim line t may be formed without providing a waste area. Thereby, the main body 2 and the lid 4 can be separated by one trimming. Further, by not providing a waste area, the dimension of the lid 4 may be maximized. As a result, the amount of overlap w may also be increased.

As shown in FIG. 9, the fixing portion 41 may be fastened using a bolt 42 and a clip 43. The clip 43 may have a U-shape, for example, and is attached to the main body stepped portion 45. One piece of the clip 43 is located between the main body stepped portion 45 and the lid stepped portion 46. In this case, the step height h3 of the main body 2 at the fixed portion 41 is set to be larger than the step height h1 in FIG. 7. Alternatively, the step height h3 in FIG. 9 may be set to be larger than the step height h1 of the main body 2 at the oblique sides 3c of the service hole 3 shown in FIG. 5. Thereby, as shown in FIG. 9, the height positions of the surface 21 of the main body 2 and the surface 22 of the lid 4 are aligned. As shown in FIG. 8, in the fixing portion 41 during press molding, a waste area 47 is provided between the main body stepped portion 45 and the lid stepped portion 46. That is, the main body stepped portion 45 and the lid stepped portion 46 of the fixing portion 41 are formed at different height positions with the waste area 47 interleaved therebetween.

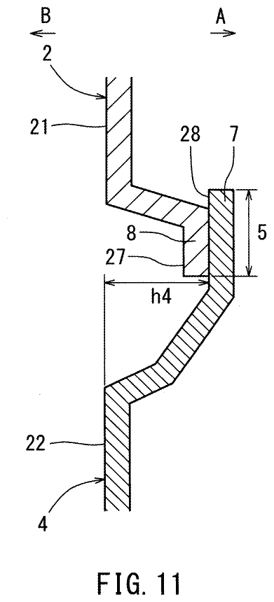

As shown in FIG. 3, the lid 4 has an insertion portion 7 on one side on its outer peripheral side. The insertion portion 7 engages with a portion of the inner peripheral side of the service hole 3. The insertion portion 7 is provided at a center of the short side 4b of the lid 4 and has a convex shape in a plan view. An engagement portion 8 corresponding to the shape of the insertion portion 7 is provided at the center of the short side 3b of the service hole 3. As shown in FIG. 11, the overlapping portion 5 is provided with a lid stepped portion 28. The lid stepped portion 28 in the overlapping portion 5 is located closer to the vehicle body side A than the main body stepped portion 27. This configuration allows the lid 4 to be temporarily assembled and then fixed to the main body 2 when covering the service hole 3 with the lid 4.

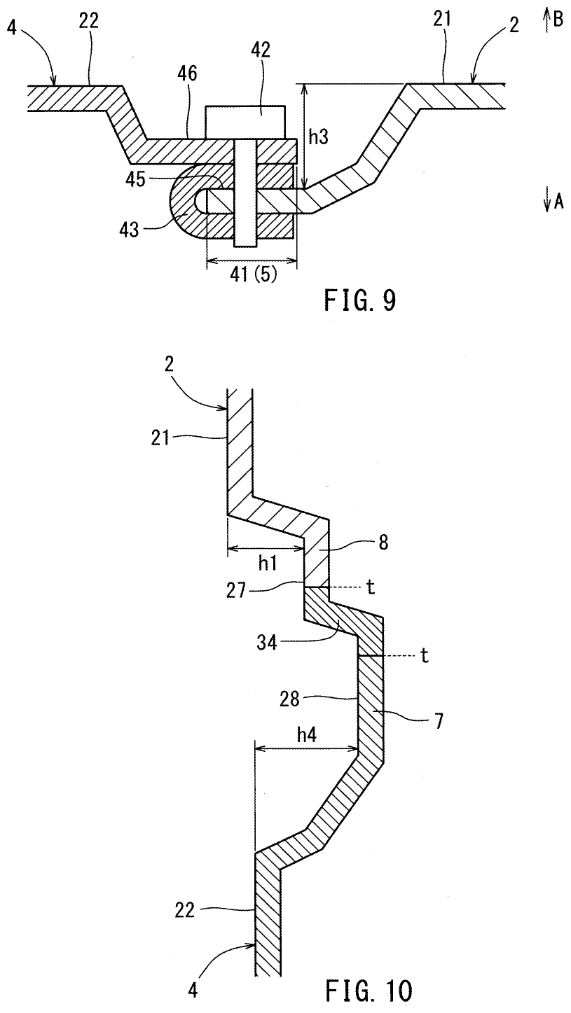

As shown in FIG. 11, since the lid stepped portion 28 is located closer to the vehicle body side A than the main body stepped portion 27, the step height h4 of the lid 4 in the insertion portion 7 is set larger than the step height h2 on the oblique sides 4c. of the lid shown in FIG. 5. As shown in FIG. 10, the insertion portion 7 and the engagement portion 8 during press molding are provided with a waste area 34 between the main body stepped portion 27 and the lid stepped portion 28. That is, the main body stepped portion 27 of the engagement portion 8 and the lid stepped portion 28 of the insertion portion 7 are formed at different height positions with the waste area 34 interleaved therebetween. The waste area 34 is trimmed by two trimming lines t. Thereby, the short side 4b of the lid 4 is separated from the main body 2 after press molding. In FIG. 10, there is a larger step height h4 of the lid stepped portion 28 between the insertion portion 7 and the engagement portion 8. As an alternative to this configuration, the step height h4 of the lid stepped portion 28 may be made substantially the same as the step height h2 shown in FIG. 5, while reducing the step height h1 of the main body stepped portion 27 to allow the insertion portion 7 to engage with the engagement portion 8.

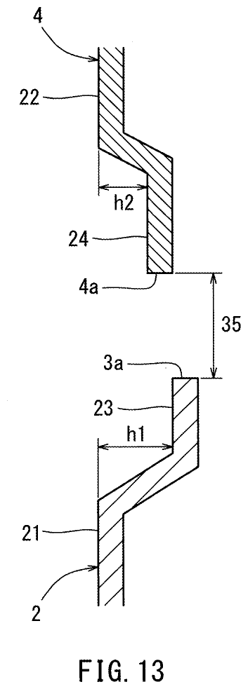

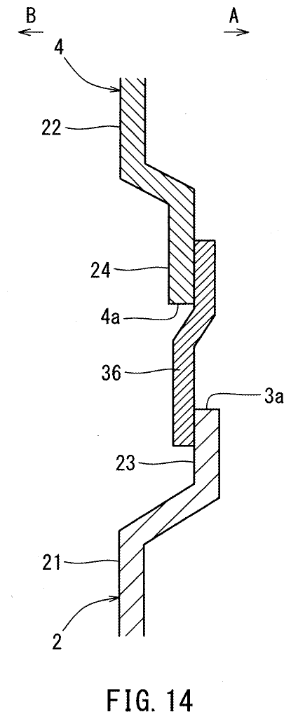

As shown in FIGS. 3 and 13, an opening 35 is formed between the long side 3a of the service hole 3 and the long side 4a of the lid 4 by the amount of slide s. The opening 35 is closed with an auxiliary member 36 formed separately from the lid 4 (see FIG. 14). The opening 35 is narrower than the entire dimension of the service hole 3 and has an elongated shape in the x-direction. Therefore, the auxiliary member 36 can be molded using a relatively narrow area of the same raw sheet from which the main body 2 is formed, such as the edge of the raw sheet, i.e., the area outside the main body 2. In this way, the lid 4 and the auxiliary member 36 for covering the service hole 3 may be respectively molded in the inner area and the limited outer area of the main body 2.

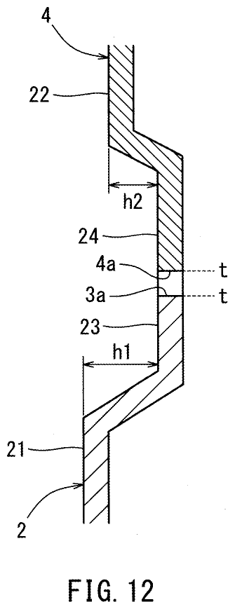

As shown in FIG. 12, the main body stepped portion 23 and the lid stepped portion 24, which face each other across the opening 35 in FIG. 13, are molded at the same height position during press molding. As shown in FIG. 14, the position where the lid 4 has slidably moved, the height position of the main body stepped portion 23 and the lid stepped portion 24 differs by the thickness of the lid. Therefore, the auxiliary member 36 is provided with a step in the thickness direction in accordance with the positional offset between the main body stepped portion 23 and the lid stepped portion 24. The auxiliary member 36 is attached to either one of the main body 2 or the lid 4 by rivets, welding, adhesive, or the like. In a configuration where the auxiliary member 36 and the lid 4 are integrated, the service hole 3 can be opened wider when the lid 4 is removed, which is preferable from the perspective of access to the vehicle accessories. Further, when the dimension of the opening 35 remaining uncovered by the lid 4 is small, the opening 35 may be used as a ventilation opening without being closed by the auxiliary member 36 or the like.

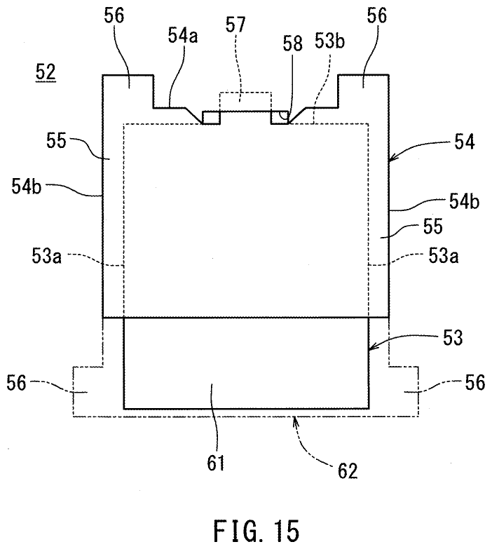

The shape of the service hole and the lid may be configured to have a substantially rectangular shape having long sides and short sides that are adjacent to each other. For example, as shown in FIG. 15, a service hole 53 and a lid 54 are formed into a substantially rectangular shape. The lid 54 covers at least a portion of the service hole 53 in a rotated orientation along the plane of a main body 52. For example, the lid 54 may be arranged in an orientation rotated by about 90 degrees from the position at the time of press molding. As a result, as shown in FIG. 15, the service hole 53 is arranged to be vertically elongated and the lid 54 is arranged to be horizontally elongated. A long side 54a of the lid 54 and a short side 53b of the service hole 53 are substantially parallel. A short side 54b of the lid 54 and a long side 53a of the service hole 53 are substantially parallel. Therefore, three sides of the lid 54 extend along the vicinity of three sides of the service hole 53. As a result, an overlapping portion 55 is formed between the three sides of the lid 54 and the three sides of the service hole 53.

As shown in FIG. 15, an insertion portion 57 that engages with an inner peripheral side of the service hole 53 is formed on an outer peripheral side of the lid 54. The insertion portion 57 is provided at a center of one long side 54a of the lid 54. An engagement portion 58 is provided on the short side 53b of the service hole 53 in accordance with a shape of the insertion portion 57. The engagement portion 58 has a rectangular shape that is wider in a lateral width than the insertion portion 57 and shorter in vertical length than the insertion portion 57. The engagement portion 58 protrudes from the center of the short side 53b of the service hole 53. The remaining opening 61 of the service hole 53 is closed with an auxiliary member 62. The auxiliary member 62 is attached to the main body 52 or the lid 54. For example, when the auxiliary member 62 is attached to the lid 54, fixing portions 56 may be provided at four corners of the integrated lid 54 and the auxiliary member 62, and fixed to the main body 52.

<Manufacturing process of vehicle undercover>

Next, a method for manufacturing the engine undercover 1 (vehicle undercover) according to the present embodiment will be described. As described above, the engine undercover 1 that covers the underside of the vehicle body has a service hole 3 that allows access to vehicle accessories, and a lid 4 that covers at least a portion of the service hole 3. The manufacturing process of the engine undercover 1 includes a press molding process, a separating process, a lid arranging process, and a lid fixing process.

In the press molding process, the main body 2 of the engine undercover 1 is molded, as shown in FIGS. 1 and 2. Specifically, after a raw sheet made of a fiber base material is heated and softened, it is interleaved from both sides by a press mold and pressurized while being cooled. As a result, a fiber molded body having a three-dimensional planar shape along the underside of the vehicle body is formed. A service hole 3 is set in a certain area of the main body 2 made of the fiber molded body. A lid 4 is formed in an inner region bordering on the peripheral edge of the service hole 3. In the separating process, the lid 4 is separated from the press-molded main body 2. That is, the separated portion of the main body 2 penetrates in the thickness direction such that the region of the service hole 3 is opened.

The service hole 3 and the lid 4 are formed into a substantially rectangular shape. Specifically, as shown in FIG. 2, they are formed into a substantially trapezoidal shape having long sides 3a, 4a and short sides 3b, 4b facing each other, and oblique sides 3c, 4c adjacent to these sides. The inclination angle θ of the oblique sides 3c and 4c of the service hole 3 and the lid 4 is freely set in consideration of the balance between the amount of slide s of the lid 4 and the amount of overlap w. The main body stepped portion 23 shown in FIG. 4 is formed on the inner peripheral side of the service hole 3 in the main body 2. For example, the main body stepped portion 23 on the oblique side 3c of the service hole 3 is located closer to the vehicle body side A than the surface 21 of the main body 2. That is, the main body stepped portion 23 has a height difference with respect to the height position of the surface 21 of the main body 2. The lid stepped portion 24 is formed on the outer peripheral side of the lid 4. The lid stepped portion 24 on the oblique side 4c of the lid 4 is located closer to the vehicle body side A than the surface 21 of the main body 2. The lid stepped portion 24 has a height difference with respect to the height position of the surface 22 of the lid 4.

As shown in FIG. 4, there is a height difference (step height h1 of the main body 2) between the surface 21 of the main body 2 and the main body stepped portion 23. There is a height difference (step height h2 of the lid 4) between the surface 22 of the lid 4 and the lid stepped portion 24. The step height h1 and the step height h2 differ by the thickness of the lid 4. In the oblique sides 3c and 4c of the service hole 3 and the lid 4, the main body stepped portion 23 and the lid stepped portion 24 are at the same height position during press molding. The surface 21 of the main body 2 and the surface 22 of the lid 4 are at different height positions by the thickness of the lid 4.

Referring to FIGS. 2 and 3, fixing portions 6 for fixing to the main body 2 at the overlapping portion 5 are provided at the four corners of the lid 4. The fixing portion 6 is a region that projects outward from the outer peripheral edge of the lid 4. In other words, the fixing portions 6 are located in wide areas in the overlapping portion 5. As shown in FIG. 6, during press molding, the main body stepped portion 23 and the lid stepped portion 24 of the fixing portion 6 are molded adjacent to each other. The main body stepped portion 23 has the same step height h1 in the entire region of the overlapping portion 5 and the fixing portions 6 along the oblique sides 3c of the service hole 3. The lid stepped portion 24 has the same step height h2 in the entire region of the overlapping portion 5 and the fixing portions 6 along the oblique sides 4c of the lid 4. The lid stepped portion 24 of the fixing portion 6 is provided with an attachment hole 26 that penetrates in the thickness direction to fix the lid 4 to the main body 2. Also in the main body 2, attachment holes 25 that penetrate the main body stepped portion 23 in the thickness direction are provided at corresponding positions where the fixing portion 6 of the lid 4 has moved in the y-direction.

Referring to FIGS. 2 and 3, the short side 4b on the outer peripheral side of the lid 4 is provided with the insertion portion 7 that engages with the short side 3b on the inner peripheral side of the service hole 3. The insertion portion 7 is formed into a convex shape extending in the y-direction from the outer peripheral edge of the lid 4 at the center of the short side 4b. At the center of the short side 3b of the service hole 3, the engagement portion 8 corresponding to the shape of the insertion portion 7 is provided. As shown in FIGS. 2 and 10, along the short sides 3b and 4b of the service hole 3 and the lid 4, a waste area 34 is set between the main body stepped portion 27 and the lid stepped portion 28 according to the shape.

As shown in FIG. 11, the insertion portion 7 enters the vehicle body side A from the main body 2. Therefore, the step height h4 of the lid 4 is greater than the step height h2 of the lid 4 at the oblique sides 4c and the fixing portions 6 (see FIG. 8). Therefore, as shown in FIG. 10, the waste area 34 is press-molded to be bent into a stepped shape at the peripheral edge of the insertion portion 7 so that the lid stepped portion 28 is located closer to the vehicle body side A than the main body stepped portion 27. As mentioned above, a waste area 34 is set when the height positions of the main body stepped portion 27 and the lid stepped portion 28 are different during press molding.

As shown in FIGS. 4 and 6, a trim line t is set at a boundary between the outer peripheral side of the lid 4 and the inner peripheral side of the service hole 3. After the main body 2 is molded, the cover part 4 is separated by cutting along the trim line t to have the service hole 3 open. In the waste area, two trim lines t are provided with the waste area interleaved therebetween. For molded parts without a waste area, a single trim line t may be provided. For example, at the oblique sides 3c and 4c of the service hole 3 and the lid 4 shown in FIGS. 3 and 4, a single trim line t may be provided. By omitting the waste area as mentioned above, the dimension of the lid 4 may be increased accordingly, and the amount of overlap w may also be increased.

In the lid arranging process, as shown in FIG. 3, the lid 4 separated from the main body 2 is shifted relative to the service hole 3 in the planar direction. The lid 4 is disposed at a position slidably moved along the plane of the main body 2 in a direction from the long side 3a to the short side 3b of the service hole 3, that is, in the y-direction. A portion of the service hole 3 is covered by the lid 4, and an overlapping portion 5 is formed in which a portion of the peripheral area of the service hole 3 and a portion of the outer peripheral area of the lid 4 overlap. The height position of the surface 22 of the lid 4 and the height position of the surface 21 of the main body 2 are aligned. The amount of slide s of the lid 4 is appropriately set depending on ensuring the amount of overlap w and the shape of the attachment holes 25 and 26 as well as the shape of the fastening member in the fixing portion 6.

As shown in FIGS. 5 and 7, the overlapping portion 5 is configured such that the main body stepped portion 23 and the lid stepped portion 24 overlap in the thickness direction. In the area along the oblique sides 3c, 4c of the service hole 3 and the lid 4 and the fixing portions 6, the lid stepped portion 24 is located closer to the road surface side B than the main body stepped portion 23. As shown in FIG. 11, the insertion portion 7 engages with the engagement portion 8 of the service hole 3. The lid stepped portion 28 of the insertion portion 7 is located closer to the vehicle body side A than the main body stepped portion 27 of the engagement portion 8. As the insertion portion 7 enters the vehicle body side A from the main body 2, the lid 4 is temporarily assembled to the main body 2.

As shown in FIG. 7, in the lid fixing step, the main body 2 and the lid 4 are fixed with bolt and nut fastening members 31 in the fixing portions 6 where the attachment holes 25 and 26 are provided. The fastening members are not limited to bolts and nuts, and can be selected as appropriate. For example, as shown in FIG. 9, a bolt 42 and a clip 43 may be used as fastening members.

As shown in FIGS. 3 and 13, a remaining opening 35 is created between the long side 3a of the service hole 3 and the long side 4a of the lid 4 by the amount of slide s of the lid 4. The opening 35 is smaller than the entire dimension of the service hole 3 and has an elongated shape in the x-direction. As shown in FIG. 14, by closing the opening 35 with the auxiliary member 36, the entire service hole 3 can be covered. The auxiliary member 36 may be press-molded using the outside area of the main body 2 on the same raw sheet used to form the main body 2. The auxiliary member 36 is attached to either one of the main body 2 or the lid 4 separated in the separating process by rivets, welding, adhesive, or the like. If the auxiliary member 36 and the lid 4 are integrally formed, the service hole 3 can be opened wider when the lid 4 is removed.

As shown in FIG. 15, the service hole 53 and the lid 54 may have a substantially rectangular shape having long sides 53a, 54a and short sides 53b, 54b that are adjacent to each other. The substantially rectangular lid 54 is arranged so as to cover at least a portion of the service hole 53 in a rotated orientation along the plane of the main body 52. For example, the service hole 53 and the lid 54 may be formed into a substantially rectangular shape. The lid 54 is arranged in an orientation rotated by about 90 degrees from the position at the time of press molding. The overlapping portion 55 is formed in a region where one long side 54a of the lid 54 and the short side 53b of the service hole 53 are close to each other. The overlapping portion 55 is formed in a region where the short side 54b of the lid 54 and a part of the long side 53a of the service hole 53 are close to each other. As a result, overlapping portions 55 are formed along three sides of the lid 54 and three sides of the service hole 53.

As shown in FIG. 15, the insert portion 57 that engages with the inner peripheral side of the service hole 53 is formed on the outer peripheral side of the lid 54. The insertion portion 57 is provided at the center of one long side 54a of the lid 54. Then engagement portion 58 is provided on the short side 53b of the service hole 53, which is close to the long side 54a of the lid 54, in accordance with the shape of the insertion portion 57. Further, the remaining opening 61 of the service hole 53 is closed with the auxiliary member 62. The auxiliary member 62 may be molded from the same raw sheet as the main body 52. Since the opening 61 is smaller than the entire service hole 53, the opening 61 may be formed even in a relatively narrow area of the raw sheet. The auxiliary member 62 is attached to the main body 52 or the lid 54. For example, the auxiliary member 62 may be attached to the lid 54 and integrated, and the fixing portions 56 may be provided at four corners.

As shown in FIGS. 1 and 3, the engine undercover 1 (vehicle undercover) according to the above embodiment includes a press-molded main body 2 and a service hole 3 that is an opening penetrating through the main body 2 in the thickness direction. The molded body, which is a separated part of an area inside the service hole 3, is used as a lid 4 that covers at least a portion of the service hole 3. The lid 4 is arranged so that a part of its outer peripheral side overlaps the peripheral edge of the service hole 3 of the main body 2. The lid 4 is fixed to the main body 2 at an overlapping portion 5 where the lid 4 and the main body 2 overlap. The overlapping portion 5 can prevent a gap from forming between the inner peripheral side of the service hole 3 and the lid 4. Further, the remaining opening 35 of the service hole 3 that is not covered by the lid 4 has a small dimension. Therefore, the opening 35 can be covered with a member that uses an area with a limited dimension of the raw sheet. Therefore, there is no need to form the lid 4 having a larger dimension than the service hole 3 outside the area of the main body 2 on the plane of the raw sheet. Therefore, it is possible to improve the material yield while ensuring the function of the lid 4 covering the service hole 3 of the main body 2.

As shown in FIG. 2, the service hole 3 and the lid 4 of the engine undercover 1 according to the above embodiment have a substantially rectangular shape with long sides 3a, 4a and short sides 3b, 4b facing each other. That is, the service hole 3 and the lid 4 are formed so that the width becomes narrower toward the short sides 3b and 4b. As shown in FIG. 3, the lid 4 is disposed at a position shifted from the long side 3a of the service hole 3 toward the short side 3b. An overlapping portion 5 is formed in a region along the short sides 3b, 4b of the service hole 3 and the lid 4, and a region along the oblique sides 3c, 4c. That is, by shifting the lid 4 separated from the main body 2 from the position of the service hole 3 in the planar direction, the overlapping portion 5 can be formed along three sides of the service hole 3 and the lid 4.

As shown in FIG. 3, in the substantially trapezoidal service hole 3 and lid 4, the inclination angle θ of the oblique sides 3c and 4c is set within an appropriate range. This ensures the amount of overlap w of the overlapping portion 5 while preventing the amount of slide s from becoming too large, thereby maintaining the remaining opening 35 small. Further, the service hole 3 is formed in a shape and size that allows easy access to vehicle accessories and maintains workability.

As shown in FIG. 3, an insertion portion 7 is provided on the outer peripheral side of the lid 4. The insertion portion 7 engages with the peripheral edge of the service hole 3. This allows the lid 4 to temporarily assemble to the main body 2. When the lid 4 is fixed to the main body 2 at the fixing portions 6, the position of the lid 4 is secured, and work efficiency can be improved. Moreover, when the lid 4 is attached to or removed from while the engine undercover 1 is attached to the underside of the vehicle body, the lid portion 4 does not fall off easily, thereby maintaining work efficiency.

As shown in FIGS. 5 and 11, the main body 2 has the main body stepped portions 23 or 27 (first stepped portion) at the peripheral edge of the service hole 3 (see FIG. 1). The lid 4 has the lid stepped portions 24 and 28 (second stepped portions) on its outer peripheral side. At the overlapping portion 5, the main body stepped portion 23, 27 and the lid stepped portion 24, 28 overlap in the thickness direction. By providing a height difference at the overlapping portions 5 of the main body portion 2 and the lid portion 4 in this manner, the service hole 3 can be covered with the surfaces 21 of the main body portion 2 and the surface 22 of the lid portion 4 aligned at the same height. In other words, it is possible to reduce the size and the number of unevenness on the surface of the road surface side B of the vehicle undercover 1.

The service hole 53 and the lid 54 shown in FIG. 15 have a substantially rectangular shape with long sides 53a, 54a and short sides 53b, 54b that are adjacent to each other. The lid 54 is rotated in the planar direction from the position at the time of press molding, and is arranged with its orientation relative to the service hole 53 changed. As a result, an overlapping portion 55 is formed between the long side 54a of the lid 54 and the short side 53b of the service hole 53. That is, by arranging the lid 54 separated from the main body 52 in a different orientation, the overlapping portion 55 may be formed along the three sides of the service hole 53 and the lid 54.

In the manufacturing process of the engine undercover 1 (vehicle undercover) according to the above embodiment, the main body 2 is formed by press molding, as shown in FIG. 2. The main body 2 is provided with a service hole 3 which is an opening passing through the thickness direction. The region inside the service hole 3 is formed as a lid 4 that covers at least a portion of the service hole 3, and is separated from the main body 2. A part of the outer peripheral side of the lid 4 is arranged so as to overlap with the peripheral edge of the service hole 3 of the main body 2 and is attached to the main body 2. An overlapping portion 5 (see FIG. 5) is formed along the peripheral edge of the service hole 3, where the lid 4 and the main body 2 overlap. This prevents a gap from forming between the peripheral edge of the service hole 3 and the lid 4.

In the press molding process, as shown in FIG. 2, the service hole 3 and the lid 4 are molded into a substantially rectangular shape having long sides 3a, 4a and short sides 3b, 4b facing each other. That is, the service hole 3 and the lid 4 are molded into a shape with the width becoming narrower toward the short sides 3b and 4b. As shown in FIG. 3, the lid 4 is disposed at a position shifted from the long side 3a of the service hole 3 toward the short side 3b. The overlapping portion 5 is formed in a region along the short sides 3b and 4b of the service hole 3 and the lid 4, and a region along two adjacent sides thereof. That is, the lid 4 separated from the main body 2 is shifted from the position of the service hole 3 in the planar direction. Thereby, the overlapping portion 5 can be formed along the three sides of the service hole 3 and the lid 4.

As shown in FIGS. 5 and 11, main body stepped portions 23 and 27 (first stepped portions) are formed on the peripheral edge of the service hole 3 (see FIG. 1) in the main body 2. Lid stepped portions 24 and 28 (second stepped portions) are formed on the outer peripheral side of the lid 4. As a result, when the lid 4 is arranged to cover at least a portion of the service hole 3, the main body stepped portions 23, 27 and the lid stepped portions 24, 28 overlap in the thickness direction to form the overlapping portion 5.

As described above, the engine undercover 1 has a structure in which the lid 4 or 54 is molded using an inner region of the service hole 3 or 53 in the main body 2 or 52. Therefore, when the arrangement, shape or the like of the service hole 3 or 53 is set, the arrangement and shape of the lid 4 or 54 during press molding are also set accordingly. Therefore, even when the arrangement and shape of the service holes 3 and 53 are various, the design can be efficiently changed. This allows the configuration of the service holes 3 and 53 and the lids 4 and 54 to be applied to various engine undercovers (vehicle undercovers). In other words, for various vehicle undercovers, it is possible to reduce material waste and improve material yield.

The vehicle undercover and its manufacturing method according to one embodiment of the present disclosure are not limited to the appearance and configuration described in the above embodiment. Various modifications, additions, deletions, and combinations of configurations may be made without departing from the gist of one embodiment of the present disclosure, and it may be implemented in various other forms.

The vehicle undercover is not limited to the engine undercover, but also includes other undercovers under the vehicle floor. For example, it may be applied to floor undercovers and the like.

The vehicle undercover including the engine undercover 1 is not limited to a press-molded body made of a fiber material but may be made of a resin material.

The main body and the lid may be press-molded in the same pressing process as described above. Alternatively, the lid may be press-molded after the main body is press-molded.

1. A vehicle undercover for covering an underside of a vehicle body comprising:
a main body made of a planar press-molded body;
a service hole formed in the main body penetrating in a thickness direction to allow access to vehicle accessories;
a lid being smaller than the service hole and configured to cover at least a portion of the service hole;
an overlapping portion where a portion of an outer periphery of the lid and a portion of a peripheral edge of the service hole overlap; and
a fixing portion configured to fix the lid and the main body at the overlapping portion.

2. The vehicle undercover according to claim 1, wherein the lid is formed using a material corresponding to the service hole to be separated from the main body.

3. The vehicle undercover according to claim 1, wherein the service hole is substantially rectangular shaped having a hole long side and a hole short side, wherein the hole short side is configured to face the hole long side, wherein the hole short side is shorter than the hole long side,
wherein the lid is substantially rectangular shaped having a lid long side being configured to face the hole long side and lid short side being configured to face the hole short side, wherein the lid short side is shorter than the lid long side, and
wherein the lid covers at least a portion of the service hole in a location where the lid has shifted in a direction from the hole long side toward the hole short side along a plane of the main body.

4. The vehicle undercover according to claim 1, wherein the main body has a first stepped portion having a height that is relatively different to a main body surface of the main body, wherein the first stepped portion is located at the peripheral edge of the service hole at the overlapping portion,
wherein the lid has a second stepped portion having a height that is relatively different to a lid surface of the lid, wherein the second stepped portion is located on an outer peripheral side of the lid at the overlapping portion, and
wherein a height position of the lid surface and a height position of the main body surface are aligned when the lid covers at least a portion of the service hole.

5. The vehicle undercover according to claim 1, wherein the lid has a convex insertion portion provided on one side on an outer peripheral side of the lid, and wherein the insertion portion is configured to engage with a portion of the main body at a peripheral edge of the service hole.

6. A method for manufacturing a vehicle undercover, the method comprising:
press-molding a planar main body;
press-molding a lid in an inner region bordering on a peripheral edge of a service hole provided in a certain region of the main body;
separating the lid from the main body to form the service hole in the main body;
forming an overlapping portion where a portion of the main body at the peripheral edge of the service hole and a portion of an outer peripheral side of the lid by shifting the lid relative to the service hole in a planar direction, and
attaching the lid to the main body at the overlapping portion.

7. The method for manufacturing the vehicle undercover according to claim 6, wherein the service hole is substantially rectangular shaped having a hole long side and a hole short side, wherein the hole short side is configured to face the hole long side, and wherein the hole short side is shorter than the hole long side,
wherein the lid is substantially rectangular shaped having a lid long side being configured to face the hole long side and a lid short side being configured to face the hole short side, wherein the lid short side is shorter than the lid long side, and
wherein the lid is disposed to cover at least a portion of the service hole in a location where the lid has shifted in a direction from the hole long side toward the hole short side along a plane of the main body.

8. The method for manufacturing the vehicle undercover according to claim 6, the method further comprising:
molding a first stepped portion at the peripheral edge of the service hole at the overlapping portion when the main body is press-molded, wherein the first stepped portion has a height that is relatively different to a main body surface of the main body, molding a second stepped portion on the outer peripheral side of the lid at the overlapping portion when the lid is press-molded, wherein the second stepped portion has a height that is relatively different to a lid surface of the lid, and
arranging the lid to cover at least a portion of the service hole so that a height position of the lid surface and a height position of the main body surface are aligned.

9. The method for manufacturing the vehicle undercover according to claim 6, the method further comprising:
molding a convex insertion portion at a peripheral edge of the lid when the lid is press-molded, and
engaging the insertion portion with a part of the main body at the peripheral edge of the service hole to temporarily assemble the lid to the main body.

10. The method for manufacturing the vehicle undercover according to claim 6 further comprises a step of forming a fiber molded body having a three-dimensional planar shape.

11. The method for manufacturing the vehicle undercover according to claim 10 further comprises a step of interleaving a raw sheet made of a fiber base material from both sides by press-molding and pressurizing after heating and softening the raw sheet.

12. The method for manufacturing the vehicle undercover according to claim 6, wherein the lid attaching step further comprises a step of attaching the main body and the lid by a fastening member.

13. A vehicle undercover for covering an underside of a vehicle body comprising:
a main body having a service hole for accessing to vehicle accessories, the service hole is configured to penetrate the main body in a thickness direction;
a lid that is smaller than the service hole and configured to cover at least a portion of the service hole;
an insertion portion configured to engage an inner peripheral side of the service hole,
an overlapping portion where a portion of an outer periphery of the lid and a portion of a peripheral edge of the service hole overlap; and
a plurality of fixing portions configured to fix the lid and the main body at the overlapping portion.

14. The vehicle undercover according to claim 13, wherein the main body has a main body stepped portion arranged at a location corresponding to the overlapping portion.

15. The vehicle undercover according to claim 13, wherein the lid has a lid stepped portion arranged at a location corresponding to the overlapping portion.

16. The vehicle undercover according to claim 13, wherein the plurality of fixing portions is provided at four corners of the lid.

17. The vehicle undercover according to claim 13, further comprising a plurality of fastening members for fixing the lid stepped portion to the main body stepped portion.

18. The vehicle undercover according to claim 13, wherein the insertion portion is formed on an outer peripheral side of the lid.

19. The vehicle undercover according to claim 13, further comprising an engagement portion provided on a short side of the service hole, wherein the engagement portion protrudes from a center of a short side of the service hole.
